(19) United States
(12) Patent Application Publication
(10) Pub. No.: US 2022/0297564 A1
(43) Pub. Date: Sep. 22, 2022

(54) A METHOD FOR CONTROLLING CHARGING OF ELECTRICALLY DRIVEN VEHICLES, A COMPUTER PROGRAM, A COMPUTER READABLE MEDIUM, A CONTROL UNIT AND A BATTERY CHARGING SYSTEM

(71) Applicant: VOLVO TRUCK CORPORATION, Göteborg (SE)

(72) Inventor: Jonas HELLGREN, GÖTEBORG (SE)

(21) Appl. No.: 17/613,071

(22) PCT Filed: May 20, 2019
(86) PCT No.: PCT/EP2019/062989

§ 371 Date: Nov. 21, 2021

(51) Int. Cl. B60L 53/62; B60L 58/12; H02J 7/00; G06Q 30/02

(52) U.S. Cl. CPC B60L 53/62; B60L 58/12; H02J 7/00032; H02J 7/0013; G06Q 30/0283; G06Q 30/0224; B60L 2260/44; B60L 2240/54

(57) ABSTRACT

Provided herein is a method for controlling the charging of at least one electrically driven vehicle of a vehicle fleet including a plurality of vehicles, the method includes the step of receiving from a first vehicle entering a charging area and a second vehicle entering the charging area after the first vehicle state of charge information and information to a spatial distance between the first vehicle and the second vehicle, and/or to a time difference of an estimated arrival time at the charging area between the first and the second vehicle. The method further includes the step of making a charging decision on the basis of said information received from said first and second vehicle, wherein said decision is selected from charging the first vehicle, or not charging the first vehicle.

### TECHNICAL FIELD

The invention relates to a method for charging of electric vehicles, particularly of at least two electrically driven vehicles entering a charging area of a vehicle fleet, a computer program, a computer readable medium, a control unit and a battery charging system.

The invention can be applied in heavy-duty vehicles, such as trucks, buses and construction equipment. Although the invention will be described with respect to a heavy-duty vehicle, the invention is not restricted to this particular vehicle, but may also be used in other vehicles such as a car.

### BACKGROUND

For electrically driven vehicles for example after a mission, it has to be decided whether or not they are charged, if they approach a charging area. For example in U.S.2018290546 A1 systems and methods of charging a fleet of electric vehicles are described including a control system that may modify the charging scheme to a bus, for instance, if the state of charge (SOC) of the bus and/or the distance to the next charging station is such that a charging event cannot be postponed. However further improvements especially with respect to a vehicle fleet are needed. In particular rules have to be established to decide on charging of more than one vehicle.

### SUMMARY

An object of the invention is to overcome problems relating to charge scheduling for electric vehicles of a vehicle fleet, in particular problems when there are more vehicles to charge than charging nodes.

According to a first aspect of the invention, the object is achieved by a method according to claim 1. In particular, a method for controlling the charging of at least one electrically driven vehicle of a vehicle fleet comprising a plurality of vehicles, the method is characterized by the steps of:
receiving from a first vehicle entering a charging area and a second vehicle entering the charging area after the first vehicle state of charge information and
   information to
      a spatial distance between the first vehicle and the second vehicle, and/or
      a time difference of an estimated arrival time at the charging area between the first and the second vehicle,
making a charging decision on the basis of said information received from said first and second vehicle, said decision being selected from
   charging the first vehicle, or
   not charging the first vehicle.

The invention is based on the recognition that problems may occur, if one vehicle blocks an after coming vehicle from charging. This includes the recognition, that this scenario is in particular critical if the distance between the vehicles is small and the second vehicle starts to run out of battery energy. The target of this invention is therefore to propose how a vehicle entering a charging area shall take a decision that is a balance between the interests of its own and other vehicles. Thus the invention allows to establish a balance between the interests of several vehicles of a vehicle fleet by taking into account not only information on the state of charge of more than one vehicle but additionally information on a distance between two vehicles.

According to one embodiment, the decision not charging the first vehicle comprises charging the second vehicle. Thus the second vehicle is charged instead of the first vehicle. In further cases after performing the method with the second and a third vehicle, the decision could be to charge the third vehicle instead of the first or the second vehicle.

Preferably the state of charge information comprises information to
a state of charge of the first vehicle, and/or
a state of charge of the second vehicle, and/or
a difference between the state of charge of the first vehicle and the second vehicle, and/or
a minimum state of charge as constraint which is not to be undercut by the state of charge of the first vehicle and/or second vehicle and/or any vehicle of the vehicle fleet.

The state of charge information thus in some embodiments not only provides information on the state of charge but also on a minimum necessary, which in any case should not be undercut. Thus it is possible to prioritize a vehicle which is on the verge to undercut the minimum or which is already below the minimum.

The received state of charge information influence the decision for example as described in the following:

A small difference in space or time between the first and second vehicle may decrease the likelihood for charge decision because lead vehicle may block after coming vehicle from charging. A low value of the state of charge of the first vehicle shall increase the likelihood for charge decision. If the difference of the states of charge of the first and the second vehicle is positive, this decreases the likelihood for charge decision because the following vehicle may be in higher need of charging. A negative value may increase the likelihood for charge decision because also state of charge balancing is desired. Balancing here means similar state of charge values between vehicles.

A further influence on the decision can be, if no charging or not-charge node in the charging area is available. In particular, if there is no free charging node, this may decrease the likelihood for charge decision because it will trigger an unnecessary waiting. If there is no free not-charge node, this may decrease the likelihood for not-charge decision because it will trigger an unnecessary waiting.

Preferably the further step of outputting a signal characterizing the charging decision is included, such that the decision can be outputted to a control unit of a vehicle or of the charging area.

In a preferred embodiment an iterative self-learning method of improvement for making of said charging decision is included. The idea of this embodiment is to formulate an artificial agent that from a set of states takes a decision on whether to charge or not. Examples of 30 relevant states are for example the state of charge information or the distance between the first and the second vehicle. The policy for taking an action is thus based on learning in a virtual or real environment. This learning can be formulated in such a way that for example the operating costs are minimized. In addition, it is preferred that the charging decision policy shall be punished if the result is that some vehicle violates a battery charge constraint.

Such a charge constraint can mean that all vehicles shall have a battery charge level above a predefined limit.

Preferably the self-learning method of improvement is defined by a self-learning charging decision algorithm, comprising the steps of
making a charging decision
determining a reward value at a time stamp after making the charging decision based on the charging decision by executing a reward function;
adapting the self-learning charging decision algorithm depending on the determined reward value,
applying the adapted self-learning charging decision algorithm in a subsequent making of the charging decision related to the same vehicles or to different vehicles.

In this embodiment at each time step, based on information on state of charge and distance a charging decision is made. One time step later, in part as a consequence of the previous decision action, a numerical reward is given. Depending on the reward value now the algorithm is adapted to further improve upcoming decisions.

The self-learning charging algorithm can be trained either in real world or off-line, especially with a simulation. It is further preferred that the algorithm is firstly trained from an off-line simulation and in the following further refined in real world during operation of the fleet in order to have an initially trained algorithm when starting operation of the algorithm in the vehicle of the fleet.

Preferably, the reward function comprises at least one penalty function for a constraint violation. With the penalty function, constraint violation can be punished, preferably in a way that a constraint violation overrules other parts of the reward function. Thus the self-learning charging decision algorithm is pushed to decisions, which do not result in constraint violation.

In a further embodiment the penalty function depends on a number of constraint violations of the first vehicle and/or the second vehicle and/or each vehicle of the vehicle fleet. Thus the more constraint violations are caused by a decision the higher the penalty can be.

The constraint is preferably a minimum state of charge for the first vehicle and/or the second vehicle and/or each vehicle of the fleet and/or the constraint is that no charging command should be given if at the charging area no free charging node is available. Thus for example the following situations can be regarded as that the operation of a fleet has failed: At least one of the vehicles has a (too) low state of charge; too low may for example be lower than 20%, as the power capability starts to decrease rapidly. Or a vehicle is commanded to charge despite the charge node is occupied. The minimum state of charge may be a global minimum for every vehicle of fleet or a specific minimum for, for example, different types of vehicle or different vehicles.

In a further embodiment the reward function considers an amount of charging energy required for charging the first and/or second vehicle and/or each vehicle of the vehicle fleet, and/or a mission time of the first vehicle and/or the second vehicle and/or each vehicle of the vehicle fleet. This has the advantage that also charging energy and thus charging time and also mission time are considered and thus influence further decisions.

Preferably the reward function depends on operating costs, in particular operating costs of the whole fleet. More preferably the operating costs are determined considering charging costs, battery degradation costs, hardware value depreciation costs, societal costs and/or salary costs for the first vehicle and/or charging costs, battery degradation costs, hardware value depreciation costs, societal costs and/or salary costs for the second vehicle. Thus the costs of the vehicle fleet can be optimized by using the self-learning charging decision algorithm.

In further embodiments also a revenue for the first and second vehicle is taken into account in the reward function. The revenue is preferably determined considering a number of moved goods of the first vehicle and/or the second vehicle and/or a value of the moved goods.

It is further preferred that the reward value at a time stamp is defined as a gap in operation costs between the time stamp and a time prior or at the prior charging decision and minus a penalty.

According to a second aspect of the invention, the object is achieved by a computer program according to claim 14. The computer program comprises program code means for performing the steps of any of any of the embodiments of the method according to the first aspect of the invention when said program is run on a computer. Furthermore, the object is achieved by the provision of a computer readable medium carrying a computer program comprising program code means for performing the steps of any of the embodiments of the method according to the first aspect when said program product is run on a computer.

According to a third aspect of the invention, the object of the invention is achieved by a charging control unit according to claim 16. The charging control unit for controlling the charging of at least one electrically driven vehicle of a vehicle fleet comprising a plurality of vehicles is configured to perform the steps of the method according to the first aspect of the invention.

In a further embodiment the charging control unit is a centralized control unit for all vehicles of the vehicle fleet.

According to a fourth aspect the invention relates to battery charging system according to claim 18, which comprises:
a charging control unit according to the third aspect of the invention, and
a vehicle control unit for at least one electrically driven vehicle of a vehicle fleet comprising a plurality of vehicles and/or
a charging area control unit for at least one charging area to charge the at least one electrically driven vehicle of the vehicle fleet.

Preferably the charging control unit and/or the charging area control unit and/or the vehicle control unit are connected with one another for communication.

In an embodiment of the battery charging system the charging control unit is integrated in the charging area control unit or in the vehicle control unit.

Further advantages and advantageous features of the invention are disclosed in the following description and in the dependent claims.

### BRIEF DESCRIPTION OF THE DRAWINGS

With reference to the appended drawings, below follows a more detailed description of embodiments of the invention cited as examples.

In the drawings:

FIG. 1 is a schematic block diagram depicting steps in an example embodiment of a method for controlling charging of at least one electrically driven vehicle of a vehicle fleet;

FIG. 2 is a schematic block diagram depicting steps in a further example embodiment of a method for controlling charging of at least one electrically driven vehicle of a vehicle fleet and

FIG. 3 is a schematic drawing of an example embodiment of a battery charging system according to the fourth aspect of the invention

### DETAILED DESCRIPTION OF EXAMPLE EMBODIMENTS OF THE INVENTION

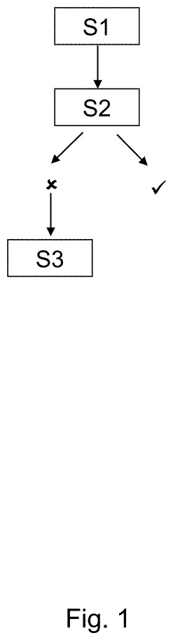

FIG. 1 is a schematic block diagram depicting steps in a preferred example embodiment of a method for controlling charging of at least one electrically driven vehicle of a vehicle fleet. Particularly, this preferred embodiment of the method comprises the following steps: in step S1 state of charge information and information to a spatial distance between a first vehicle and a second vehicle or to a time difference of an estimated arrival time at a charging area between the first and the second vehicle is received from the first vehicle entering the charging area and the second vehicle, which enters the charging area after the first vehicle. The state of charge information preferably comprises information the state of charge of the first and second vehicle and/or on a difference of these states of charge. Furthermore information on a minimum state of charge as constraint which is not to be undercut by the state of charge of the first vehicle and/or second vehicle and/or any vehicle of the vehicle fleet can be included, such that preferably no vehicle's state of charge is too low. In step S2 a charging decision is made on the basis of said information received from said first and second vehicle, said decision being selected from charging the first vehicle, or not charging the first vehicle. If the decision is not to charge the first vehicle in step 3 in a preferred embodiment the decision is taken to charge the second vehicle.

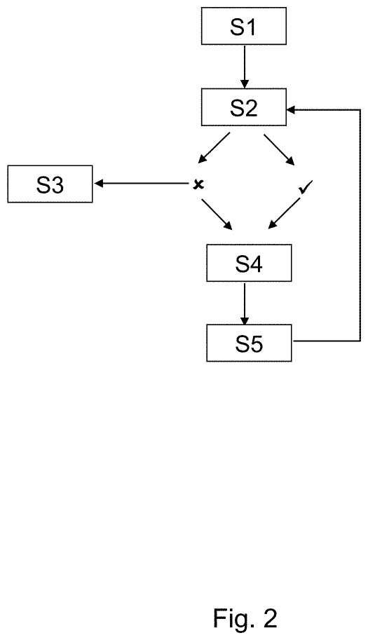

FIG. 2 is a schematic block diagram depicting steps in a further example embodiment of a method for controlling charging of at least one electrically driven vehicle of a vehicle fleet. The method of FIG. 2 corresponds to the method according to FIG. 1 but further comprises a self-learning method of improvement, in particular a self-learning charging decision algorithm with the steps S4 and S5, which refer back on step S2. After making a charging decision in step S2 in the shown embodiment in step S4 a reward value at a time stamp after making the charging decision is determined based on the charging decision by executing a reward function. In the following step S5 the self-learning charging decision algorithm is adapted depending on the determined reward value. Subsequently the adapted self-learning charging decision algorithm is applied in a subsequent making of the charging decision in step 2 related to the same vehicles or to different vehicles.

The reward function executed in step S4 in order to determine the reward value comprises in this embodiment two penalty function for a constraint violation. The first penalty function is penalty function for a first constraint being a minimum state of charge for each vehicle of the fleet. For example the minimum state of charge may be 20%. The second penalty function is a penalty functions for a second constraint, in that no charging command should be given if at the charging area no free charging node is available. Another possibility is penalty function for a constraint, that no not charging command should be given, if at the charging area no free no-charge node is available.

The reward function in this embodiment further depends on operating costs. The operating costs are determined considering charging costs, battery degradation costs, hardware value depreciation costs, societal costs and/or salary costs for the first vehicle and/or charging costs, battery degradation costs, hardware value depreciation costs, societal costs and/or salary costs for the second vehicle. Lower costs are preferred. The reward functions thus punishes constraint violation and remunerates low costs.

30 In the following a further example of a method including a self-learning charging decision algorithm is described schematically.

In the following the learner and decision-maker is called the agent. The thing it interacts with, comprising everything outside the agent, is called the environment.

More specifically, the agent and environment interact at each of a sequence of discrete time steps, t=0, 1, 2, 3, . . . At each time step t, the agent receives some representation of the environment's state, Sₜ and on that basis selects an action, Aₜ ∈A (Sₜ), where A (Sₜ) is the set of actions available in state Sₜ. One time step later, in part as a consequence of its action, the agent receives a numerical reward, Rₜ₊₁∈Rₜ, and finds itself in a new state, Sₜ₊₁. According to the invention self-learning is used with the ambition to avoid operation failure, e.g. some vehicle has to low state of charge (SoC).

10 The state space used is

s=(SoCₐ,ΔSoC,rg) (1)

where

ΔSoC=SOCₐ₋SoC_{b} (2)

SoCₐ is the state of charge of the first vehicle, and SoC_{b} is the state of charge of the second vehicle. rg means the relative gap (in time or space) between the first and the second vehicle.

There are two actions, which can be applied after the decision:

$$a = ( \begin{matrix}1 & ( charging is preferable ) \\ 0 & ( … not … )\end{matrix} \qquad ( 3 )$$

During an episode, actions will be requested or taken at specific time instants. These are denoted tᵢ. These time events also correspond to when the learning agent will receive reward feedback. The reward for an action at time tᵢ will be returned at time tᵢ₊₁. The reward is defined as

Rᵢ₊₁=−penᵢ₊₁ (4)

where

penᵢ₊₁=P·socfail (5)

socfail=(min(S̅o̅C̅)<SOCₘᵢₙ) (6)

In this embodiment the reward is solely based on the penalty function for violating a constraint for a minimum state of charge. If any vehicle of the fleet infringes the constraint, the reward is negative.

Another embodiment considers also the costs besides the penalty function:

Rᵢ₊₁=−Δcₒₚₑᵣ−penᵢ₊ᵢ (⁷)

where

Δcₒₚₑᵣ=cₒₚₑᵣ _{ᵢ₊ᵢ}−cₒₚₑᵣ_{ᵢ} (8)

This is the change of total cost of running the fleet. If no vehicle are charged between tᵢ and tᵢ₊₁Δcₒₚₑᵣ is zero.

cₒₚₑᵣ=c_{elec}·E_{charge}+c_{chrent}·t_{charge} (⁹)

These are the total costs of running the fleet. Herein taking into account the charging costs and rental cost for a charging slot. It increases as soon as some vehicle is charged. For example cₒₚₑᵣ is increased first after a charging is finished. Initially the charging slot rental cost c_{chrent} can be set as zero. Furthermore a term for battery degradation can be added.

penᵢ₊₁=P·socfail (10)

socfail=(min(S̅o̅C̅)<SoCₘᵢₙ) (11)

With this embodiment also costs are taken into account in order to improve the charging decision.

Training of the agent, in other words training of the algorithm starts preferably as training from off-line simulation in order to have an initially trained algorithm when starting operation of the algorithm in the vehicle of the fleet. Then the training of the algorithm is continued in real world during operation.

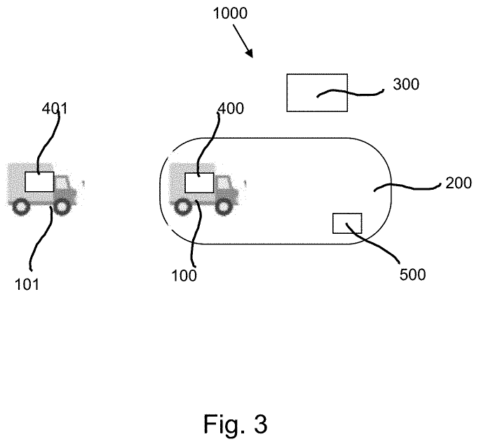

FIG. 3 is a schematic drawing of an example embodiment of a battery charging system 1000, which comprises in the shown embodiment a charging control unit 300, two vehicle control units 400, 401 for each of shown the electrically driven vehicles 100, 101 of a vehicle fleet comprising a plurality of vehicles and a charging area control unit 500 for the charging area 200 to charge the at least one electrically driven vehicle of the vehicle fleet. In the shown embodiment the charging control unit 300 is configured to perform the steps of the method according to the first aspect of the invention, in particular receiving from the first vehicle 100 entering the charging area 200 and from the second vehicle 101 entering the charging area after the first vehicle state of charge information and information to a spatial distance between the first vehicle and the second vehicle, and/or a time difference of an estimated arrival time at the charging area between the first and the second vehicle. Furthermore, the charging control unit 300 is configure to make a charging decision on the basis of said information received from said first and second vehicle 100,101, said decision being selected from charging the first vehicle 100, or not charging the first vehicle 100, but instead charging the second vehicle 101. Thus the charging control unit is able to prioritize the charging of the vehicles and thus to avoid that a charging node is blocked by a first vehicle without considering if the charging of the following vehicle is more urgent than the charging of the first vehicle.

The charging control unit 300 in the shown embodiment furthermore is able to perform a self-learning method of improvement, which is defined by a self-learning charging decision algorithm, comprising the steps of making a charging decision, determining a reward value at a time stamp after making the charging decision based on the charging decision by executing a reward function; adapting the self-learning charging decision algorithm depending on the determined reward value and subsequently applying the adapted self-learning charging decision algorithm in a subsequent making of the charging decision related to the same vehicles or to different vehicles. The reward function preferably considers total costs of operating the fleet as well as a penalty function for a constraint violation, if one vehicle of the fleet has a state of charge lower than a defined minimum state of charge for all vehicles of the fleet.

It is to be understood that the present invention is not limited to the embodiments described above and illustrated in the drawings; rather, the skilled person will recognize that many changes and modifications may be made within the scope of the appended claims.

1. A method for controlling the charging of at least one electrically driven vehicle of a vehicle fleet comprising a plurality of vehicles, the method comprising the steps of:
receiving from a first vehicle entering a charging area and a second vehicle (101) entering the charging area after the first vehicle
state of charge information and
information to
a spatial distance between the first vehicle and the second vehicle (101), and/or
a time difference of an estimated arrival time at the charging area between the first and the second vehicle,
making a charging decision on the basis of said information received from said first and second vehicle, said decision being selected from
charging the first vehicle, or
not charging the first vehicle.

2. A method according to claim 1, wherein not charging the first vehicle comprises charging the second vehicle.

3. A method according to claim 1, wherein the state of charge information comprises information to
a state of charge of the first vehicle and/or
a state of charge of the second vehicle, and/or
a difference between the state of charge of the first vehicle and the second vehicle, and/or
a minimum state of charge as constraint which is not to be undercut by the state of charge of the first vehicle and/or second vehicle and/or any vehicle of the vehicle fleet.

4. A method according to claim 1, further comprising outputting a signal characterizing the charging decision.

5. A method according to claim 1, wherein an iterative self-learning method of improvement for making of said charging decision is included, wherein an artificial agent is formulated that from a set of stakes takes a decision on whether to charge or not.

6. A method according to claim 5, characterized in that the self-learning method of improvement is defined by a self-learning charging decision algorithm, comprising the steps of:
making a charging decision;
determining a reward value at a time stamp after making the charging decision based on the charging decision by executing a reward function;
adapting the self-learning charging decision algorithm depending on the determined reward value; and
applying the adapted self-learning charging decision algorithm in a subsequent making of the charging decision related to the same vehicles or to different vehicles.

7. A method according to claim 6, wherein the reward function comprises at least one penalty function for punishing a constraint violation, wherein the self-learning charging decision algorithm is pushed to decisions, which do not result in constraint violation.

8. A method according to claim 7, wherein the penalty function depends on a number of constraint violations of the first vehicle and/or the second vehicle and/or each vehicle of the vehicle fleet.

9. A method according to claim 7, wherein the constraint is a minimum state of charge for the first vehicle and/or the second vehicle and/or each vehicle of the fleet and/or the constraint is that no charging command should be given if at the charging area no free charging node is available.

10. A method according to claim 6, wherein the reward function considers an amount of charging energy required for charging the first and/or second vehicle and/or each vehicle of the vehicle fleet, and/or a mission time of the first vehicle and/or the second vehicle and/or each vehicle of the vehicle fleet.

11. A method according to claims 6 wherein the reward function depends on operating costs.

12. A method according to claim 11, wherein the operating costs are determined considering charging costs, battery degradation costs, hardware value depreciation costs, societal costs and/or salary costs for the first vehicle and/or charging costs, battery degradation costs, hardware value depreciation costs, societal costs and/or salary costs for the second vehicle.

13. A method according to claim 6, wherein the reward value at a time stamp is defined as a gap in operation costs between the time stamp and a time prior or at the prior charging decision and minus a penalty.

14. A computer program comprising program code means for performing the steps of claim 1 when said program is run on a computer.

15. A computer readable medium carrying a computer program comprising program code means for performing the steps of claim 1 when said program is run on a computer.

16. A control unit for controlling the charging of at least one electrically driven vehicle, the control unit configured to perform the steps of the method according to claim 1.

17. A control unit according to claim 16 characterized in that the charging control unit is a centralized control unit for all vehicles of the vehicle fleet.

18. A battery charging system comprising:
a charging control unit according to claim 16, and
a vehicle control unit for at least one electrically driven vehicle of a vehicle fleet comprising a plurality of vehicles and/or
a charging area control unit for at least one charging area to charge the at least one electrically driven vehicle of the vehicle fleet.

19. A battery charging system according to claim 18, wherein the charging control unit and/or the charging area control unit and/or the vehicle control unit are connected with one another for communication.

20. A battery charging system according to claim 18 wherein the charging control unit is integrated in the charging area control unit or in the vehicle control unit.
